(19) United States
(12) Patent Application Publication
(10) Pub. No.: US 2008/0095243 A1
(43) Pub. Date: Apr. 24, 2008

(54) H.264 decoding method and device for detection of NAL-unit error

(75) Inventors: Young-O Park, Seongnam-si (KR); Young-Hun Joo, Yongin-si (KR); Kwang-Pyo Choi, Anyang-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/906,355

(22) Filed: Oct. 2, 2007

(30) Foreign Application Priority Data
Oct. 20, 2006 (KR) 102597/2006

(51) Int. Cl. H04N 7/12

(52) U.S. Cl. 375/240.24

(57) ABSTRACT

Provided is an H.264 decoding method and device for detection of Network Abstract Layer (NAL) unit error. The method includes calculating a total macroblock count for one picture, calculating a difference between a previous frame count and a current frame count, whenever a NAL unit is received, counting a macroblock count whenever decoding the macroblock, until the one picture is made complete, setting information indicating that one erroneous picture is made complete when the counted macroblock count is less than the total macroblock count and reporting that the one erroneous picture is made complete when the difference is greater than “0”.

### CLAIM OF PRIORITY

This application claims the benefit of the earlier filing date, under 35 U.S.C. §119(a), to that patent application filed in the Korean Intellectual Property Office on Oct. 20, 2006 and assigned Serial No. 2006-102597, the entire disclosure of which is hereby incorporated by reference.

### BACKGROUND OF THE INVENTION

1. Field of the Invention

The present invention relates to an H.264 decoding device, and in particular, to an H.264-based decoding method and device for enabling normal decoding in circumstances in which errors occur.

2. Description of the Related Art

H.264 is a recommended protocol relating to a video codec proposed by International Telecommunication Union (ITU-T). H.264 is one of a packet-based moving picture compression technology applicable to a videoconference and broadcasting and streaming services.

H.264, which is a highly efficient compression technology, is based on a Network Abstract Layer (NAL) unit, wherein encoding and decoding is performed on the basis of the NAL unit. The NAL unit can be constructed of several slices within one picture, or constitute one picture. In general, one image is composed of a plurality of successive pictures. A picture displayed on one screen is made up of a plurality of slices. Each of the slices is composed of a plurality of macroblocks including a plurality of pixels. Each slice includes a slice header representing information on the slice.

However, there is no information for informing a start and an end of one picture within the NAL unit as, there is only information on a frame number (frame_num) of a current NAL unit and a first macroblock number (first_mb_in_slice) of a current slice. Accordingly, a conventional H.264 decoding device increases a decoded macroblock count (mb_cnt) whenever decoding of one macroblock ends. The H.264 decoding device can recognize whether one picture is made complete using a condition where the macroblock count (mb_cnt) is equal to a total macroblock count (mb_tot_num) of one picture.

Accordingly, the H.264 decoding device has no way to check whether one picture is made complete when an error occurs in the NAL unit. Thus, the H.264 decoding device cannot apply an appliance of an upper layer, such as an Error Concealment (EC) algorithm for concealing the error when there an error occurs. FIG. 1 is an exemplary diagram illustrating a case where there occurs an NAL error within one picture in a related art. It is assumed that a black colored portion represents an NAL unit in one picture constituted of a plurality of macroblocks.

FIG. 1 shows a case where a macroblock count (mb_cnt) is equal to “0” before decoding of a macroblock starts, and the macroblock count (mb_cnt) increases by one whenever decoding of one macroblock ends. However, if an error occurs in mid course, the macroblock count (mb_cnt) is not counted as an erroneous macroblock. Therefore, a finally counted macroblock count (mb_cnt) is not consistent with a total macroblock count (mb_tot_num) despite resultant completion of decoding of one picture. Thus, the H.264 decoding device has no way to distinguish whether an error exists in a current picture or whether the current picture is made complete. Furthermore, the H.264 device cannot perform normal decoding because of malfunction of the H.264 decoding device itself.

As described above, the conventional H.264 decoding device determines whether one picture is normally made complete using a counted macroblock count and a total macroblock count. Accordingly, in case where the picture includes an error, the counted macroblock count is not consistent with the total macroblock count, so that the H.264 decoding device has no way to check whether one picture is made complete. This can cause a malfunction of the H.264 decoding device, thereby causing damage to an entire system.

### SUMMARY OF THE INVENTION

An aspect of exemplary embodiments of the present invention is to address at least the problems and/or disadvantages and to provide at least the advantages described below. Accordingly, an aspect of exemplary embodiments of the present invention is to provide an H.264 decoding method and device for detection of an NAL unit error.

Another aspect of exemplary embodiments of the present invention is to provide an H.264 decoding method and device for implementing normal decoding although an error occurs in the NAL unit.

According to one aspect of exemplary embodiments of the present invention, there is provided an H.264 decoding method for detection of Network Abstract Layer (NAL) unit errors. The method includes calculating a total macroblock count for one picture, checking a previous frame count and a current frame count, and calculating a difference between the previous frame count and the current frame count whenever every NAL unit is received, counting a macroblock count whenever decoding the macroblock until the one picture is made complete, setting information indicating that one erroneous picture is made complete when the counted macroblock count is less than the total macroblock count and reporting that the one erroneous picture is made complete, when the difference is greater than “0”.

According to another aspect of exemplary embodiments of the present invention, there is provided an H.264 decoding device for detection of an NAL unit error. The device includes a frame count processor for calculating a total macroblock count for one picture, and, when every NAL unit is received, checking a previous frame count and a current frame count and calculating a difference between the previous frame count and the current frame count, a macroblock decoding processor for counting a macroblock count whenever decoding the macroblock, until the one picture is made complete, and setting information indicating that one erroneous picture is made complete when the counted macroblock count is less than the total macroblock count and a picture error detector for reporting that the one erroneous picture is made complete when the difference is greater than “0”.

### BRIEF DESCRIPTION OF THE DRAWINGS

The above features and advantages of the present invention will become more apparent from the following detailed description when taken in conjunction with the accompanying drawings in which:

FIG. 1 is an exemplary diagram illustrating a case where an NAL error occurs within one picture in a related art;

FIG. 2 is a schematic block diagram illustrating a construction of an H.264 decoding device according to the present invention;

FIGS. 3 to 5 are flowcharts illustrating an exemplary method for processing an erroneous picture according to an embodiment of the present invention;

FIG. 6 is an exemplary diagram illustrating a case where a slice error occurs within one picture according to an exemplary embodiment of the present invention; and

FIG. 7 is an exemplary diagram illustrating a case where an error occurs because one or more pictures themselves are lost according to an exemplary embodiment of the present invention.

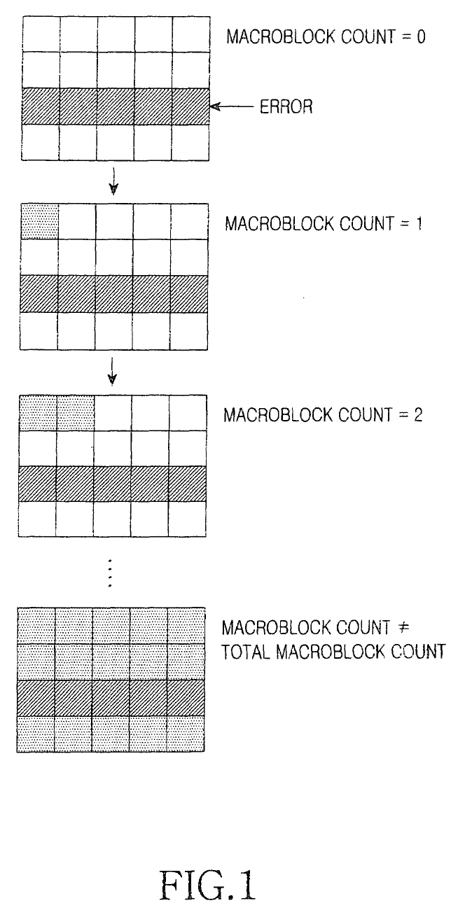

Throughout the drawings, the same drawing reference numerals will be understood to refer to the same elements, features and structures.

### DETAILED DESCRIPTION OF THE INVENTION

Exemplary embodiments of the present invention will now be described in detail with reference to the annexed drawings. For the purposes of clarity and simplicity, a detailed description of known functions and configurations incorporated herein has been omitted for conciseness.

The present invention provides a method for detecting an NAL unit error, and implementing normal decoding in an H.264 decoding device. For this, the present invention checks a frame number (frame_num) of a current NAL unit received from a network terminal, calculates a difference with a previous NAL unit, and recognizes an end of one picture by a change in the frame number. The present invention checks a situation where there occurs an error, using the difference value, and reports a corresponding state to an upper layer at each situation. Accordingly, the H.264 decoding device has an advantage of implementing the normal decoding without system malfunction even though there occurs an NAL error, as well as applying an appliance of an upper layer such as an error concealment algorithm.

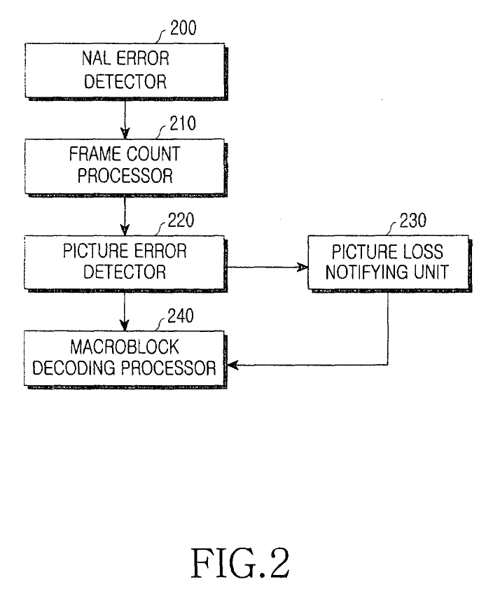

FIG. 2 is a schematic block diagram illustrating the architecture of an H.264 decoding device according to the present invention.

Referring to FIG. 2, the H.264 decoding device includes an NAL error detector 200, a frame count processor 210, a picture error detector 220, a picture loss notifying unit 230, and a macroblock decoding processor 240.

The NAL error detector 200 determines whether there exists an error in a received NAL unit. The NAL error detector 200 analyzes a header of the NAL unit and determines whether there exists the error in the NAL unit on the basis of a value that is set to a forbidden zero bit (fzb) field of the header. The fzb field is constituted of 1 bit, and is set to a fixed value (in this illustrated case, “0”. However, it will be recognized that the values described herein are used for illustrative purposes and the use of similar or other values are considered within the scope of the invention.) When there occurs an error in the course of transmitting the NAL unit from a network to the H.264 decoding device, the fzb field is set to a second value (e.g., “1”). Accordingly, the NAL error detector 200 can recognize the receipt of the erroneous NAL unit, and stop decoding, in cases when the fzb field is set to “1”. The NAL error detector 200 returns an S264_NAL_ERROR value to an upper layer to stop the decoding. The S264_NAL_ERROR value refers to a value predefined with the upper layer provide information that the NAL unit has an error. After the S264_NAL_ERROR value is returned to the upper layer, the NAL error detector 200 passes to next NAL unit processing.

The frame count processor 210 checks a frame number (frame_num) from a slice header of a current NAL unit, and calculates a difference (dif_fn) between the frame number of the current NAL unit and a frame number of a previous NAL unit. The frame number of the previous NAL unit is updated and stored to calculate a difference with a frame number of a next NAL unit, every time a NAL unit is processed. The calculated difference is used as a criterion for determining an end of one picture. The calculated difference is transmitted to the picture error detector 220.

The picture error detector 220 determines a change in the picture using the difference value, determines whether an erroneous picture is made complete, and reports the determination result to the upper layer, in case where one picture is comprised of one or more NAL units. The picture error detector 220 further returns an S264_INCOMPLETE_PIC_MADE value to the upper layer to provide information that the erroneous picture is made complete

The macroblock decoding processor 240 decodes a macroblock until one picture is made complete, where one picture is not yet made complete or the difference is equal to or less than “0”. Accordingly, the macroblock decoding processor 240 counts and increases the macroblock count whenever the decoding of one macroblock ends. The macroblock decoding processor 240 determines that one picture is nominally made complete when the counted macroblock count is equal to the total macroblock count. Thus, the macroblock decoding processor 240 returns an S264_COMPLETE_PIC_MADE value to the upper layer provide information that one picture is made complete. When one picture is made complete, a variable (pic_made) is set to “TRUE”. This variable is used for the picture error detector 220 to determine whether an erroneous picture is made complete.

The macroblock decoding processor 240 returns an S264_OK value to the upper layer to provide information that processing of one NAL unit is completed when a counted macroblock count is less than the total macroblock count. The macroblock decoding processor 240 in this case determines that one picture is made complete with an error, and sets the variable (pic_made) to “FALSE” when the counted macroblock count is not equal to the total macroblock count.

The picture error detector 220 determines whether there is the difference at the time of the next NAL unit processing when the variable (pic_made) is set to “FALSE.” When the difference is greater than “0”, the picture error detector 220 returns to the upper layer an S264_INCOMPLETE_PIC_MADE value for providing information that the erroneous picture is made complete.

The picture loss notifying unit 230 initiates an operation when one picture corresponds to one NAL unit and the difference is equal to or greater than “2”. That the difference is equal to or greater than “2” means that there occurs at least one error in two or more pictures. When the two or more pictures are lost as above, the picture loss notifying unit 230 increases a previous frame count, thereby returning an S264_ONE_PIC_LOST value to the upper layer as many times as the number of the lost pictures.

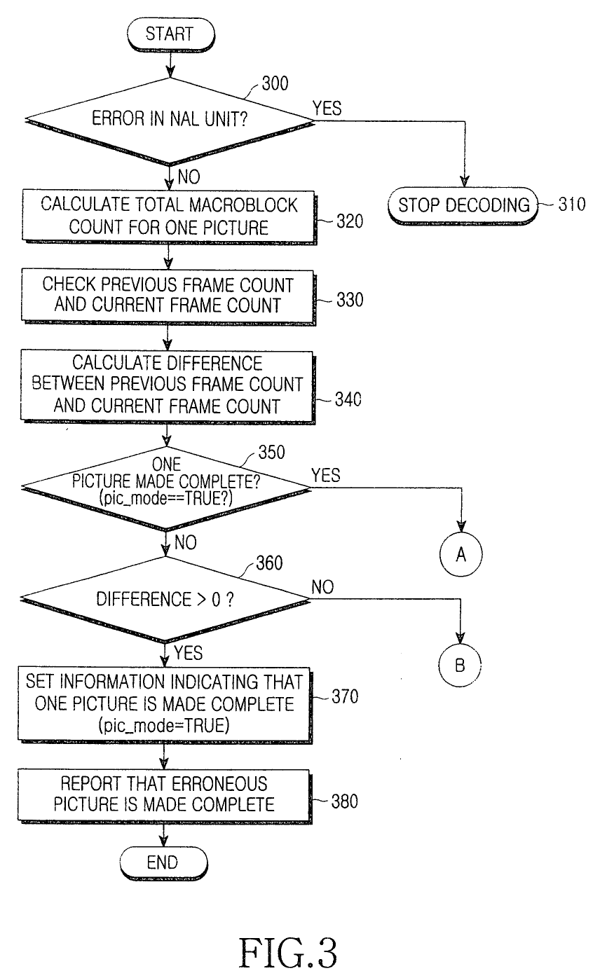

An operation of detecting the NAL error and simultaneously implementing the normal decoding in the H.264 decoding device will be described with reference to FIGS. 3 to 5. FIGS. 3 to 5 are flowcharts illustrating a method for processing the erroneous picture according to an exemplary embodiment of the present invention.

Referring to FIG. 3, the H.264 decoding device determines whether there exists an error in the received NAL unit in Step 300. The determination on whether there exists an error in the NAL unit is implemented in the NAL error detector 200. The NAL error detector 200 determines that there exists an error when the fzb field of the header of the NAL unit is set, (e.g., “1”). The H.264 decoding device returns the S264_NAL_ERROR value to the upper layer to stop the decoding in Step 310, when there exists an error in the NAL unit. Thus, the H.264 decoding device processes the next NAL unit processing.

The H.264 decoding device calculates the total macroblock count (mb_tot_num) for one picture in Step 320, when an error in the NAL unit does not exist. The H.264 decoding device checks the previous frame count and a current frame count in Step 330, and calculates the difference between the previous frame count and the current frame count in Step 340. This operation is performed in the frame count processor 210 of the H.264 decoding device. The difference (dif_fn) can be obtained as:

dif_{—}fn=abs(cur_{—}fn−prn_{—}fn),

wherein
the previous frame count is denoted by “prn_fn”,
the current frame count is denoted by “cur_fn”, and
the difference is denoted by “dif_fn”.

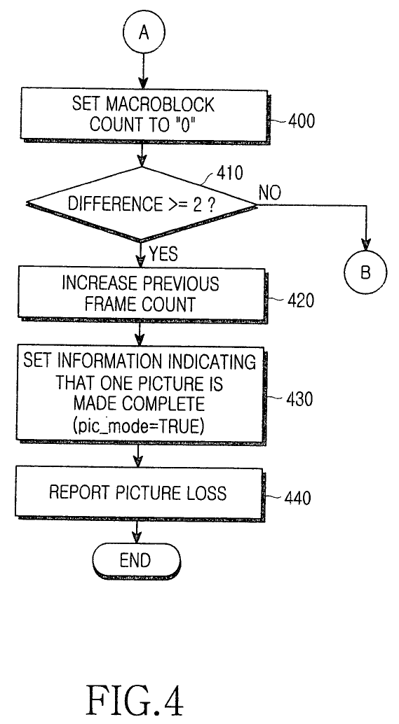

After that, the H.264 decoding device determines whether one picture is made complete in Step 350. For this, it is determined whether the variable (pic_made) is set to “TRUE”. It is desirable that an initial pic_made is set to “TRUE”. The H.264 decoding device proceeds to Step 400 of FIG. 4 when one picture is made complete, i.e., the variable (pic_made) is set to “TRUE”. Symbol “A” is used to indicate connection between the Step 350 of FIG. 3 and the Step 400 of FIG. 4.

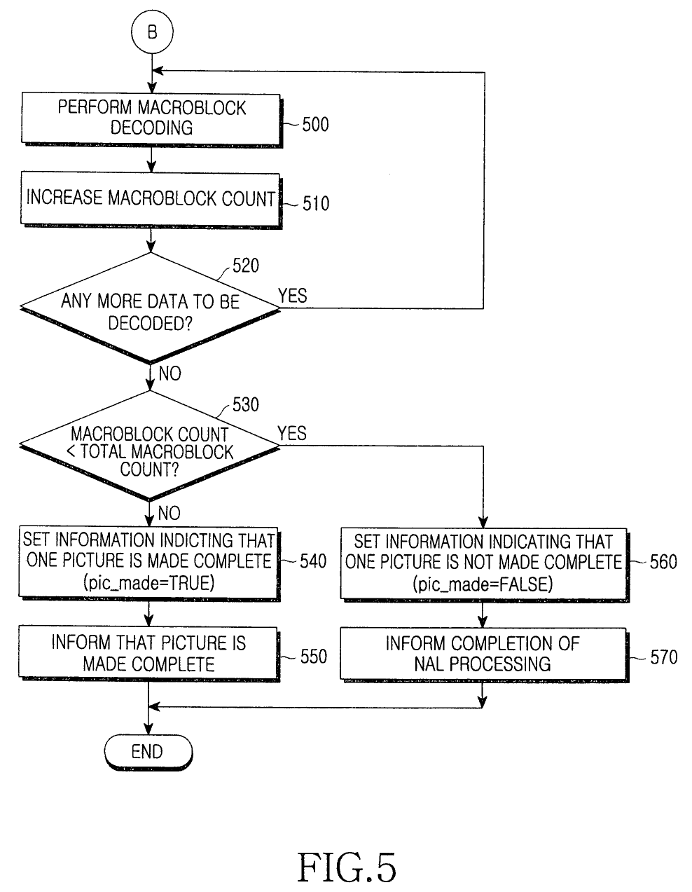

The H.264 decoding device determines whether the difference is greater than “0” in Step 360 when one picture is not made complete when the variable (pic_made) is not set to “TRUE” in the Step 350. The H.264 decoding device proceeds to Step 500 of FIG. 5 when the difference is not greater than “0”. Symbol “B” is used to indicate that the Step 360 of FIG. 3 and the Step 500 of FIG. 5 connect with each other.

The H.264 decoding device sets information indicating that one picture is made complete in Step 370 when the difference is greater than “0” in the Step 360. Thus, the variable (pic_made) is set to “TRUE”. When the difference is greater than “0”, there is a difference between the previous frame count and the current frame count. Thus, the H.264 decoding device can recognize the end of the picture by generation of the difference value. After that, in Step 380, the H.264 decoding device returns the S264_INCOMPLETE_PIC_MADE value to report that the erroneous picture is made complete. Operations of Steps 350 to 380 are implemented in case where one picture is comprised of one or more NAL units.

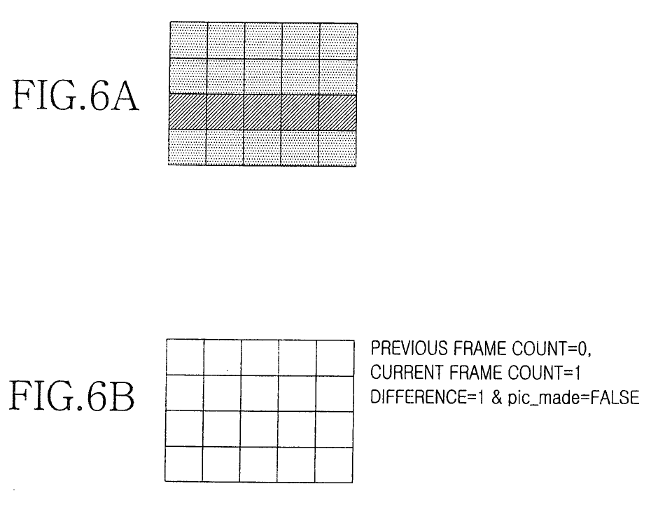

A case where there occurs an error in one picture comprised of one or more NAL units will be described in detail with reference to FIGS. 6A and 6B wherein a slice error occurs within one picture and is determined according to an exemplary embodiment of the present invention. In detail, FIG. 6A shows a case where the erroneous picture is made complete and FIG. 6B shows a case where a next picture is received. When the previous frame count (prn_fn) is equal to “0” and the current frame count (cur_fn) is equal to “1” as in FIG. 6B, the difference (dif_fn) is equal to “1”, and the variable (pic_made) is set to “FALSE” because one picture is made complete including an error. In other words, because the difference (dif_fn) is greater than “0” (dif_fn>0), the H.264 decoding device returns the S264_INCOMPLETE_PIC_MADE value to the upper layer, and informs that an erroneous picture is made complete.

When one picture is made complete in the Step 350 (returning to FIG. 3), the H.264 decoding device sets the macroblock count (mb_cnt) to “0” in the Step 400 of FIG. 4. After that, the H.264 decoding device determines whether the difference is equal to or greater than “2”. If it is determined that the difference is equal to or greater than “2”, the H.264 decoding device proceeds to Step 420, and otherwise, it proceeds to Step 500 of FIG. 5. Symbol “B” is used to indicate that the Step 410 of FIG. 4 and the Step 500 of FIG. 5 connect with each other. Thus, Step 500 of FIG. 5 is performed when the difference is not greater than “0” in the Step 360 and when the difference is less than “2” in the Step 410 of FIG. 4.

When it is determined that the difference is equal to or greater than “2” in the Step 410, the H.264 decoding device increases the previous frame count (prn_fn++) in Step 420, and sets information indicating that one picture is made complete in Step 430. Thus, the variable (pic_made) is set to “TRUE”. After that, the H.264 decoding device reports a picture loss in Step 440. The H.264 decoding device returns the S264_ONE_PIC_LOST value to the upper layer to inform that two or more pictures are lost. The steps 410 to 440 are performed in case where one picture is comprised of one NAL unit.

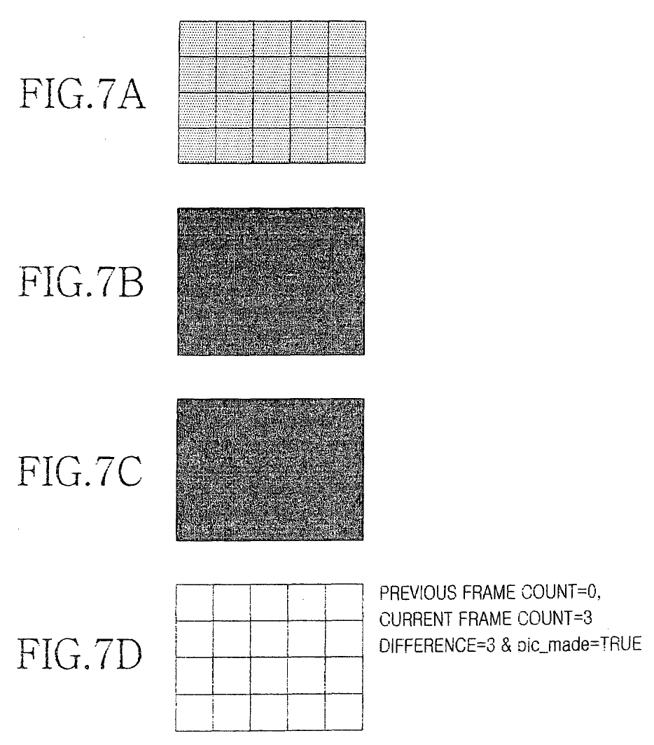

A case where one picture is composed of one NAL unit will be described in detail with reference to FIGS. 7A-7D wherein there occurs an error because one or more pictures are lost. FIG. 7A shows a picture in which normal decoding is performed, FIGS. 7B and 7C show cases where two pictures are lost, and FIG. 7D shows a case where a next picture is received. In these figures, two pictures are lost. Therefore, the current frame count (cur_fn) is equal to “3” and thus, the difference is equal to “3”, when the previous frame count (prn_fn) is equal to “0”. In this case, the H.264 decoding device increases the previous frame count (prn_fn) and then, returns the S264_ONE_PIC_LOST value, thereby providing information that the first picture is lost. After that, the above procedure is repeated to return the S264_ONE_PIC_LOST value, thereby providing information that the second picture is lost. In other words, the S264_ONE_PIC_LOST value is returned as many times as the number of the lost pictures, thereby informing the upper layer of the number of occurrences of the picture loss.

The H.264 decoding device performs a macroblock decoding process in Step 500 of FIG. 5, when the difference is not greater than “0” in the Step 360 of FIG. 3 and when the difference is less than “2” in the Step 410 of FIG. 4. Then, after decoding one macroblock, the H.264 decoding device increases the macroblock count (mb_cnt++) in Step 510 and then, determines whether there is more data to be decoded in Step 520, thereby repeating an operation of increasing the macroblock count (mb_cnt++) whenever the decoding of the macroblock ends.

When there is no longer data to be decoded, the H.264 decoding device determines whether the counted macroblock count (mb_cnt) up to now is less than the total macroblock count (mb_tot_num) in Step 530. When it is determined not less, that is, when the macroblock count (mb_cnt) is equal to the total macroblock count (mb_tot_num), the H.264 decoding device recognizes that one picture is nominally decoded. Accordingly, the H.264 decoding device sets information indicating that one picture is made complete in Step 540 and thus, sets the variable (pic_made) to “TRUE”. Then, the H.264 decoding device returns the S264_COMPLETE_PIC_MADE value to the upper layer to inform that the picture is normally made complete in Step 550.

When it is determined that the counted macroblock count (mb_cnt) is less than the total macroblock count (mb_tot_num), the H.264 decoding device sets information indicating that one picture is not nominally made complete in Step 560 and thus, sets the variable (pic_made) to “FALSE”. The H.264 decoding device informs that NAL processing is completed in Step 570. For this, the H.264 decoding device returns the S264_OK value to the upper layer. That the counted macroblock count is less than the total macroblock count means that the macroblock decoding is not performed because an NAL error occurred.

According to the present invention as above, the H.264 decoding device has an advantage of implementing the normal decoding without system malfunction although there occurs an NAL error in the H.264 decoding device. Also, the present invention has an advantage of checking the situation where there occurs an error using the difference value and reporting a corresponding state to the upper layer at each situation thereby applying the appliance of the upper layer such as the error concealment algorithm.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. Thus, the computer or processor when loaded with the instructions or computer code operates as an apparatus for executing the processing shown herein.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An H.264 decoding method for detection of Network Abstract Layer (NAL) unit error, the method comprising the steps of:
calculating a total macroblock count for one picture;
calculating a difference between a previous frame count and a current frame count whenever every NAL unit is received;
counting a macroblock count whenever decoding the macroblock until the one picture is made complete;
setting information indicating that one erroneous picture is made complete when the counted macroblock count is less than the total macroblock count; and
reporting that the one erroneous picture is made complete when the difference is greater than “0”.

2. The method of claim 1, further comprising the steps of:
setting information indicating that the one picture is made complete when the counted macroblock count is equal to the total macroblock count; and
reporting that the one picture is made complete to an upper layer.

3. The method of claim 1, further comprising after the calculating of the difference value:
initializing the macroblock count when setting information indicating that the one picture is made complete;
determining whether the difference is equal to or greater than “2”;
decoding the macroblock while counting the initialized macroblock count until the one picture is made complete, when the difference is less than “2”; and
recognizing that the picture itself is lost, and reporting to the upper layer as many times as the number of the lost pictures, when the difference is equal to or greater than “2”.

4. The method of claim 3, further comprising the step of:
increasing the previous frame count when the difference is equal to or greater than “2”.

5. The method of claim 1, further comprising the step of:
determining whether there exists an error on the basis of a slice header of the received NAL unit; and
reporting to an upper layer to stop decoding when there exists the error.

6. An H.264 decoding device for detection of an NAL unit error, the device comprising:
a frame count processor for calculating a total macroblock count for one picture, and, when every NAL unit is received, calculating a difference between a previous frame count and a current frame count;
a macroblock decoding processor for counting a macroblock count whenever decoding the macroblock, until a picture is made complete, and setting information indicating that one erroneous picture is made complete when the counted macroblock count is less than the total macroblock count; and
a picture error detector for reporting that the one erroneous picture is made complete when the difference is greater than “0”.

7. The device of claim 6, wherein the macroblock decoding processor sets information indicating that the one picture is made complete when the counted macroblock count is equal to the total macroblock count and reports that the one picture is made complete, to the upper layer.

8. The device of claim 6, further comprising:
a picture loss notifying unit for recognizing that the picture itself is lost, and reporting to the upper layer as many times as the number of the lost pictures when the difference is equal to or greater than “2”.

9. The device of claim 6, further comprising:
an NAL error detector for determining whether there occurs an error on the basis of a slice header of the received NAL unit, and reporting to the upper layer to stop decoding when there exists the error.
